(19) United States
(12) Patent Application Publication
(10) Pub. No.: US 2008/0264346 A1
(43) Pub. Date: Oct. 30, 2008

(54) Bird stand with paper towel dispenser for lining perch

(76) Inventor: Adolfo T. Mazzucco, Mississauga (CA)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/148,048

(22) Filed: Apr. 16, 2008

Related U.S. Application Data
(60) Provisional application No. 60/914,367, filed on Apr. 27, 2007.

(51) Int. Cl. A01K 31/04

(52) U.S. Cl. 119/471; 119/479

(57) ABSTRACT

Apparatus for use by a bird and for use with a roll of sheet material is disclosed. The apparatus includes a body, a perch and a support. The body is for receiving said roll of sheet material and for permitting said sheet material to be unfurled from said roll, the body having a structure over which said sheet material unfurled from the roll can be positioned. The perch is for said bird. The support is operatively fixedly secured to the body and to the perch to retain the perch at an operative position over the structure such that matter dropped by said bird when in use of the perch lands upon said sheet material positioned upon the structure.

### FIELD OF THE INVENTION

The present invention relates to the field of perches for birds.

### BACKGROUND OF THE INVENTION

It is well-known to provide cages or perches for birds. As birds have a tendency to soil their surroundings, it is known to provide a receiver beneath the cage/perch, and to line the receiver with newspaper or the like, which can be removed and replaced as needed.

### SUMMARY OF THE INVENTION

Apparatus for use by a bird and for use with a roll of sheet material forms one aspect of the invention. The apparatus comprises a body, a perch and a support. The body is for receiving said roll and permitting said sheet material to be unfurled from said roll, and has a structure over which said sheet material unfurled from the roll can be positioned. The perch is for said bird. The support is operatively fixedly secured to the body and to the perch to retain the perch at an operative position over the structure such that matter dropped by said bird when in use of the perch lands upon said sheet material positioned upon the structure.

According to another aspect of the invention, the sheet material can be a paper towel web.

The apparatus provides a bird perch which can be relatively easily and inexpensively relined.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 is a front elevational view of apparatus constructed according to an exemplary embodiment of the invention;

FIG. 2 is a side elevational view of the apparatus of FIG. 1;

FIG. 3 is a top plan view of the apparatus of FIG. 1;

FIG. 4 is a view of the apparatus of FIG. 1 in use with a roll of sheet material, the apparatus being shown as if viewed along section A-A of FIG. 3; and

FIG. 5 is a side elevational view of apparatus according to a further exemplary embodiment of the invention.

### DETAILED DESCRIPTION

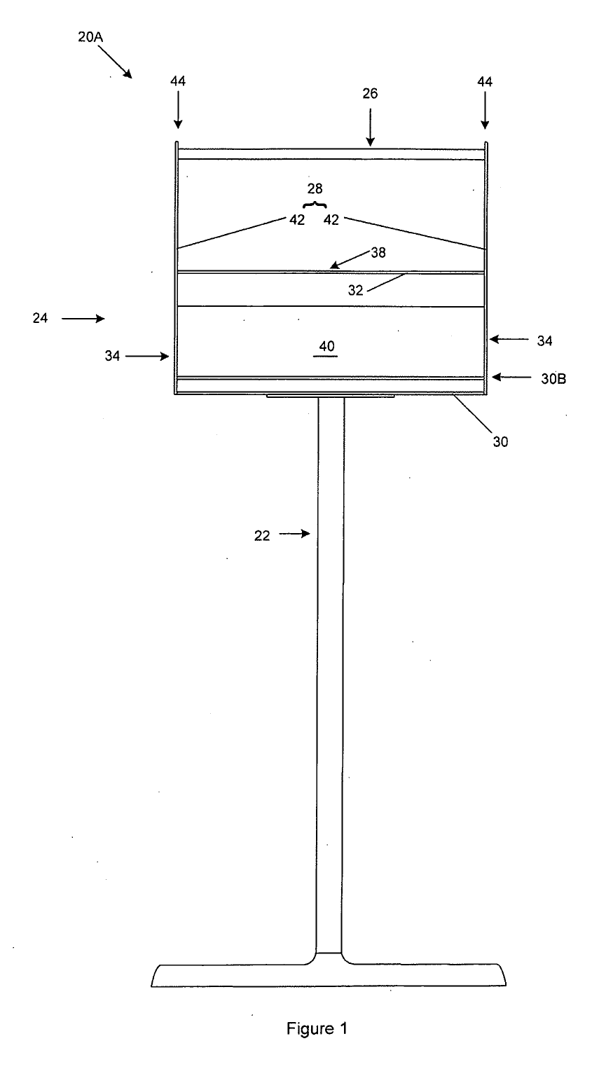

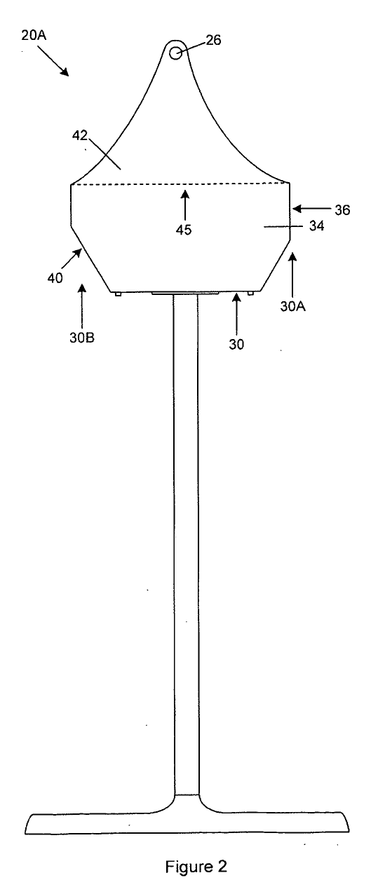

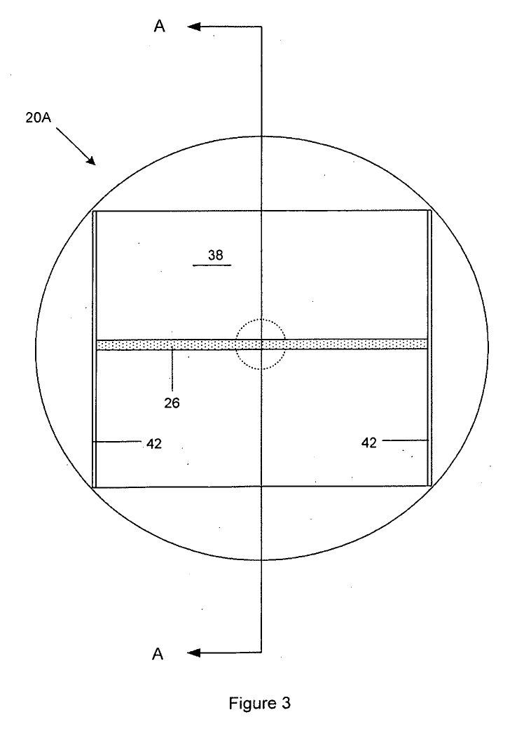

Apparatus according to an exemplary embodiment of the invention is illustrated in FIGS. 1-3 and indicated with general reference numeral 20A. Although not shown, the apparatus 20A should be understood to be for use with a bird, such as a cockatiel, and will be seen to comprise a base 22, a body 24, a perch 26 and a support 28.

The base 22 is of the pedestal type, which rests upon the ground or a floor surface in use.

The body 24 includes a bottom 30, a top 32, side walls 34 and an end wall 36. The bottom 30 is substantially trough-shaped. The top 32 is a structure disposed above and in spaced relation to the bottom 30 and having an upper planar surface 38. The side walls 34 extend one from each side of the bottom 30 to the top 32. End wall 36 extends from one end 30A of the bottom 30 (that is, one lip of the trough) to the top 32. The bottom 30, top 32, side walls 34 and end wall 36 collectively define a housing having an end opening 40 bounded by the side walls 34, the top 32 and the other end 30B of the bottom 30 (i.e. the other lip of the trough).

The perch 26 is a horizontally-orientated length of plastic having an outer cylindrical surface dimensioned such that it can be comfortably gripped by the feet of said bird for perching.

The support 28 is operatively fixedly secured to the body 24 and to the perch 26 to retain the perch 26 at an operative position over the structure/top 32 and comprises a pair of planar support members 42 spaced apart from one another, orientated substantially vertically and spanned by the perch 26. The upper edges 44 of support members 42 are sufficiently narrow that same cannot be comfortably gripped by the feet of said bird for perching. Each support member 42 has a substantially triangular shape, with the base thereof being horizontal and aligned with the upper surface 38. As shown, the support members 42 form extensions of side walls 34, such that the bases thereof are notional, and accordingly shown in dotted outline as 45. However, this need not be the case, and support members 42 could be defined by discrete elements with physical bases.

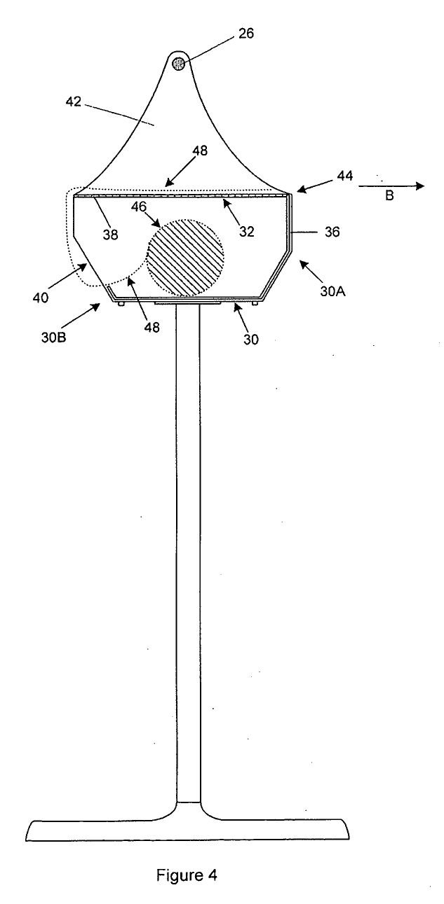

The manner in which the apparatus 20A is used is evidence from FIG. 4. In use, a roll 46 of paper toweling or other sheet material or webbing 48 is disposed beneath the top 32, i.e. in the housing, drawn through the opening 40 and overlain upon the upper surface 38 of the top 32. Since the sheet material 48 is positioned upon the surface 38, any matter (not shown) dropped by said bird when in use of the perch 26 lands upon said sheet material 48.

The combination of the shape of support members 42 and the dimensioning of the upper edges 44 thereof so as to be unsuitable for perching deter the bird from perching on the support 28, such that the bird is inclined to remain on the perch 26 and such that substantially all of such matter lands upon the sheet material 48. When the toweling or other sheet material 48 has become soiled, tension can be applied to such soiled sheet material, to draw same away from the top 32, i.e. in the direction of arrow B and in the same process to cause fresh material to be unfurled from the roll 46 and drawn across the top 32 of the housing. The soiled paper can then be cut from the balance of the web, or, when the web is of the type that is perforated periodically to provide a plurality of frangible pieces, simply detached along an appropriation line of perforations.

In the course of such unfurling, the roll 46 may roll upon the bottom 30 of the housing towards the end opening 40, but will impinge upon the other lip of the trough before rolling out, and the mass of the roll 46 will normally be such that the roll will rotate in sliding contact against the trough, rather than exiting therefrom through the opening 40.

Once the roll 46 is substantially depleted, its lesser mass makes it more prone to dislodgement. Accordingly, in such situations, a user may unfurl the roll with one hand applying tension to the free end of the sheet, and the other hand steadying the roll in the housing, to avoid dislodgement. Alternatively, the user may elect to draw paper with two hands applying tension, since, if the roll should dislodge from the housing when substantially depleted, there will be little material to unfurl, with the result that such inadvertent dislodgement would not be unduly troublesome.

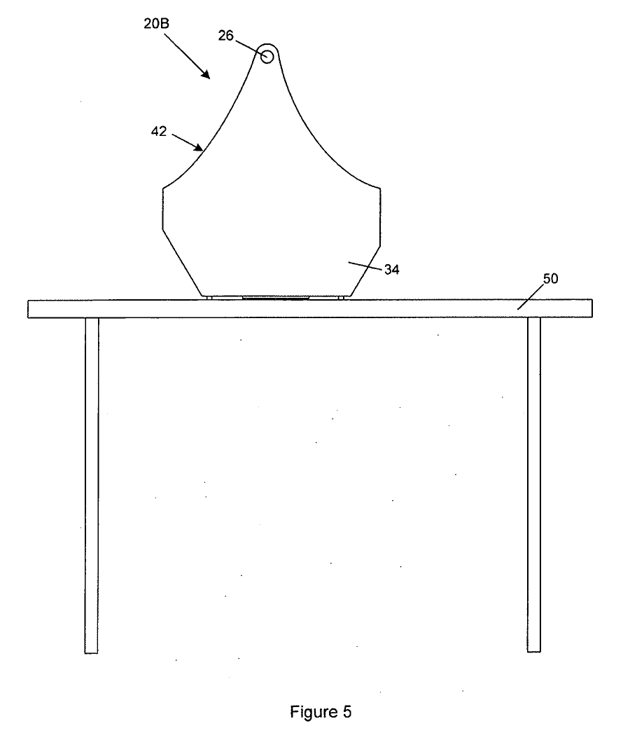

Apparatus 20B according to a second exemplary embodiment of the invention is illustrated in FIG. 5. This apparatus 20B is intended for use on a table top 50 or similar surface, and thus lacks a base, but otherwise is identical in construction and function to the embodiment 20A of FIGS. 1-4, and thus is not described herein further.

While but two embodiments of the present invention have been herein shown and described, it will be understood that variations are contemplated.

For example, it should be understood that the size of the apparatus and of the perch may need to be adjusted to accommodate the size of the bird with which the apparatus is to be used.

As well, the width of the surface and the spacing of the supports may be adjusted to reflect the length of the roll of sheet material, i.e. the web width.

Additionally, the end walls, bottom and side wall could all be eliminated and a spindle could be provided beneath the “top” structure for dispensing the sheet material.

Further, whereas the perch is specified herein to be constructed out of plastic, other materials, such as wood, could be utilized.

As well, whereas the material of construction of the balance of each apparatus is not specified, it will be understood that same could routinely be constructed out of materials such as steel and aluminum, and also with plastics including but not limited to acrylic.

Accordingly, the scope of the invention should be understood to be limited only by the claims appended hereto, purposively construed.

1. Apparatus for use by a bird and for use with a roll of sheet material, said apparatus comprising:
a body for receiving said roll and permitting said sheet material to be unfurled from said roll, said body having a structure over which said sheet material unfurled from the roll can be positioned;
a perch for said bird; and
a support operatively fixedly secured to the body and to the perch to retain the perch at an operative position over the structure such that matter dropped by said bird when in use of the perch lands upon said sheet material positioned upon the structure.

2. Apparatus according to claim 1, wherein the support is configured in a manner to deter said bird from perching thereon in use.

3. Apparatus according to claim 2, wherein the support comprises a pair of planar support members orientated substantially vertically in use and spanned by the perch.

4. Apparatus according to claim 3, wherein the bird is deterred from perching on the support by shaping and dimensioning the upper edges of the support members so as to be unsuitable for perching.

5. Apparatus according to claim 4, wherein each support member is dimensioned such that the upper edge thereof is sufficiently small that same cannot be comfortably gripped by the feet of said bird for perching.

6. Apparatus according to claim 5, wherein each support member has a substantially triangular shape, the base thereof being horizontal and aligned with the upper surface of the structure over which the sheet material is positioned in use.

7. Apparatus according to claim 1, further comprising a pedestal base upon which the body is mounted.

8. Apparatus according to claim 1, wherein the perch is a piece of plastic having a cylindrical outer surface and oriented substantially horizontally in use.

9. Apparatus according to claim 1, wherein the body is a housing having a top which defines the structure and overlies said roll in use.

10. Apparatus according to claim 1, wherein the body is adapted to permit said sheet material to be unfurled from the roll in use by being drawn from the roll.

11. Apparatus according to claim 1, wherein the body has a bottom which supports the roll in use, the bottom being adapted such that, as sheet material is drawn from the roll in use, the roll rotates in sliding contact with the bottom.

12. Apparatus according to claim 1, wherein
the body is a housing including: a trough-shaped bottom in which said roll is positioned in use; a top disposed above and in spaced relation to the bottom and defining the structure; end walls extending one from each end of the bottom to the top; and a side wall extending from one side of the bottom to the top;
the housing has a side opening bounded by the end walls, the top and the other side of the bottom; and
the bottom is adapted such that, as sheet material is drawn, in use, from the roll, through the side opening, the roll rotates in sliding contact with the bottom.

13. Apparatus according to claim 1, wherein the body is a housing having a top which defines the structure and overlies said roll in use, the body being adapted to permit sheet material to be drawn from the roll by tension applied to the sheet material positioned upon the structure.

14. Apparatus according to claim 12, wherein the body is adapted to permit sheet material to be drawn from the roll by tension applied to the sheet material positioned upon the structure.

15. Apparatus for use by a bird and for use with a roll of paper toweling, said apparatus comprising:
a body for receiving said roll and permitting said paper toweling to be unfurled from said roll, said body having a structure over which said paper towel unfurled from the roll can be positioned;
a perch for said bird; and
a support operatively fixedly secured to the body and to the perch to retain the perch at an operative position over the structure such that matter dropped by said bird when in use of the perch lands upon said sheet material positioned upon the structure.
